(19) United States
(12) Patent Application Publication
(10) Pub. No.: US 2008/0196046 A1
(43) Pub. Date: Aug. 14, 2008

(54) Method and Apparatus for Providing Information Content for Display on a Client Device

(75) Inventors: Gregrory J. Athas, Lisle, IL (US); David Wisti, Buffalo Grove, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Novarra, Inc., Itasca, IL (US)

(21) Appl. No.: 12/028,263

(22) Filed: Feb. 8, 2008

Related U.S. Application Data
(60) Provisional application No. 60/889,137, filed on Feb. 9, 2007.

(51) Int. Cl. G06F 9/46

(52) U.S. Cl. 719/320

(57) ABSTRACT

A method and apparatus are provided that process information content for display on a client device. The information content includes scripting commands that are not executable on the client device. A function of the scripting commands is determined. The scripting commands are replaced in the information content with browser commands that are executable on the client device to perform the function of the scripting commands. The browser commands may be written using an nScript Applicaton Programming Interface (API). The nScript API extends the Hypertext Markup Language (HTML) and provides an interface to a reduced functionality scripting engine (RFSE). The information content is then sent to the client device. A client browser on the client device may utilize one or more scripting engine functions of the RFSE to execute the browser commands.

### CROSS REFERENCE TO RELATED APPLICATION

The present patent application claims priority under 35 U.S.C. § 119(e) to U.S. Provisional Patent Application Ser. No. 60/889,137, filed on Feb. 9, 2007, the entire contents of which are incorporated herein by reference as if fully set forth in this description.

### FIELD OF INVENTION

The present application relates generally to the field of web browsing and network communications. More specifically, the application relates to a method and apparatus for transforming and presenting information from web pages containing content designed for large computers to a small device, such as a cellular telephone or a personal digital assistant (PDA).

### BACKGROUND

Today, many worldwide web pages (HTML documents) are available that offer a variety of textual and non-textual content types. On a traditional desktop or laptop computer with a large screen running a standard web browser, these content types are easily arranged and displayed for viewing. For example, web sites for displaying photographic images may deliver a plurality of images for a viewer to examine one at a time. Each image in the plurality of images may be displayed for a fixed amount of time as a slideshow, or may be displayed responsive to input from the viewer, such as clicking on a “next image” button.

At the same time, the field of communications, and more specifically wireless telecommunications, is currently undergoing a radical expansion. This technological expansion allows a small, handheld, electronic device, such as a personal digital assistant (PDA), cellular telephone, pager, and other electronic devices, to connect to the same information sources, such as a web server or database, as one could with a personal computer (PC) and a PC-based browser. Several small device client browsers are available which display content from the web to the handheld devices.

However, these small devices typically lack the screen space, processing power, or navigation capabilities to display web content intended for display on a desktop or laptop computer. Thus, there are a number of techniques client browsers utilize to assist the user in navigating the web pages on the small screens. For example, client browsers may alter the layout of web content, change the positioning of images, or simply not display some web content.

Scripting commands within web content such as an HTML document, written in JavaScript or a similar scripting language, also provide a challenge to the display of content on small devices. Scripting commands executed on a PC-based browser may generate some or all of the information content available to a user of the PC-based browser. However, small device support for scripting commands is limited, at best, due to the smaller memory and processing power available on the small device.

### SUMMARY

In a first principle aspect, an exemplary embodiment provides a method of processing information content for display on a client device. In accordance with the method, information content is received. The information content includes one or more scripting commands. The one or more scripting commands are not executable on the client device. A function of the one or more scripting commands is determined. In the information content, the one or more scripting commands are replaced with one or more browser commands that are executable on the client device. The information content is sent to the client device.

In a second principle aspect, a server is provided. The server includes a processor for executing software applications stored in memory and a client device interface. The software applications include a server browser. The server browser receives information content from an information source. The information content includes one or more scripting commands that are not executable on a client device. The server browser determines a function of the scripting commands and determines one or more browser commands to replace the scripting commands. The browser commands perform the determined function of the scripting commands. The browser commands include one or more nScript browser commands that are executable on the client device.

The server browser assembles transformed information content by: (a) removing the scripting commands from the information content, (b) determining one or more insertion positions within the information content for the browser commands, and (c) inserting the browser commands into the information content at the insertion positions. The client device interface sends the transformed information content.

These as well as other aspects and advantages will become apparent to those of ordinary skill in the art by reading the following detailed description, with reference where appropriate to the accompanying drawings. Further, it should be understood that the embodiments described in this summary and elsewhere are intended to be examples only and do not necessarily limit the scope of the invention.

### BRIEF DESCRIPTION OF FIGURES

Exemplary embodiments of the invention are described herein with reference to the drawings, in which:

FIG. 1 is a block diagram of an example system for accessing, adapting, and presenting information content to electronic devices;

FIG. 2A shows an example browser window of a client browser displaying content of an example Hypertext Markup Language (HTML) anchor element;

FIG. 2B shows an example web page displayed as a result of clicking on the content of an example HTML anchor element;

FIGS. 3A, 3B, and 3C each show an example client browser window of a client browser after executing nScript browser commands shown in Table 4;

FIGS. 4A and 4B each show a client browser window of a client browser after executing nScript browser commands shown in Table 5;

FIG. 5 is an example block diagram of a server; and

FIG. 6 is a flowchart depicting example functional blocks of a method of processing information content for display on a client device.

Reference numerals are shown in the drawings to identify various elements of the drawings. Drawing elements having identical reference numerals are substantially identical or identical elements.

### DETAILED DESCRIPTION

Information content that relies on the use of scripting commands may not be readily displayable by a client browser on a small device, if the client browser does not support the execution of the scripting commands. To provide information content containing scripting commands to the small device, typically the scripting commands are executed on a server to generate information content. Then, the server sends the generated information content to the small device. Sending the generated information content from the server to the small device requires additional communication which incurs network overhead and delay.

It is desirable to adapt information content containing scripting commands for display on a device other than an originally intended device with lower communication overhead. The information content may be adapted by transforming the information content, such as by replacing the scripting commands with browser commands executable on the client browser on the small device. The browser commands may replace scripting commands that perform common operations on the information content. Examples of common operations on the information content include navigating among a group of items created in the information content and controlling visibility of each item in the group of items.

An embodiment comprises a server that transforms the information content by replacing scripting commands with browser commands. The scripting commands may be written in JavaScript or a similar scripting language. The browser commands are executable on the client browser and may be written using the nScript Application Programming Interface (API). As described herein, the nScript API extends the Hypertext Markup Language (HTML) by supporting operations on groups of related items and by handling events in the client browser. To execute nScript API browser commands, the support of a reduced functionality scripting engine (RFSE) of the client browser may be required.

### 1. AN EXEMPLARY SYSTEM FOR PRESENTING INFORMATION CONTENT

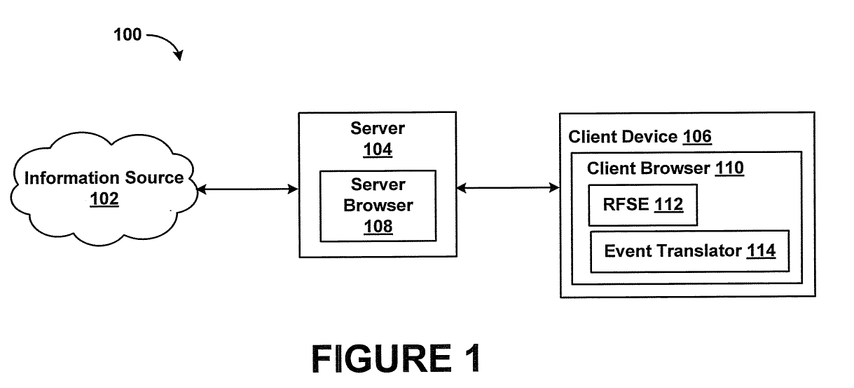

Referring now to FIG. 1, a block diagram is shown of a system 100 for accessing, adapting, and presenting information content to electronic devices. The system 100 includes an information source 102, a server 104 and a client device 106.

The information source 102 includes any type of device such as a web server, application server, database or other backend system, or any interface to an information provider. The information source 102 provides information content expressed in a markup language, such as those markup languages known in the art including HTML, Extensible Markup Language (XML) with or without Extensible Style Sheets (XSL), VoiceXML, Extensible Hypertext Markup Language (XHTML), or Wireless Markup Language (WML). Furthermore, the information content can reference images, video, or audio information to be provided by the information source 102.

The information source 102 can be accessed through any type of network by the server 104 via a server browser 108. The server browser 108 may communicate with the client device 106 over any type of network through a client browser 110. The server browser 108 acts as a proxy between the client browser 110 and the information source 102 of web page content for viewing. The server browser 108 may operate as a client of the information source 102 to retrieve the information content. For example, using a known suite of communications protocols such as Transmission Control Protocol/Internet Protocol (TCP/IP), the server browser 108 can issue a Hypertext Transfer Protocol (HTTP) request to the information source 102.

By utilizing HTTP requests, such as is known in the art, the server browser 108 can access information content, including applications, static and dynamic content, at the information source 102. Dynamic content, such as dynamic web pages, can be written in scripting languages such as JavaScript, developed by Netscape (www.netscape.com), Jscript, VBScript, Visual Basic, and C#, all of which were developed by Microsoft (www.microsoft.com), and/or Tcl. JavaScript is also a component of Dynamic HTML (DHTML), which is an alternative technology for delivering rich internet applications with interactive animated content.

The server browser 108 and the client browser 110 may reside on the same platform or may be separate from each other. For example, the server browser 108 might be hosted on a back-end server, and the client browser 110 might be hosted on a hand-held electronic device, as shown in FIG. 1. However, it should be understood that the server browser 108 and client browser 110 can be hosted on the same platform such as on an electronic device, if the platform or electronic device has the appropriate hardware and network capabilities. Thus, within many embodiments herein, functionality may be described as being part of the client browser 110 or as being part of the server browser 108.

It should be understood that the client device 106 and the server 104 may co-exist on the same device, and thus functionality of either can be substituted by each other. Thus, the client browser 110 may perform functions explained as being performed by the server browser 108, and the server browser 108 may perform functions explained as being performed by the client browser 110. By utilizing the server and client browser, smaller electronic devices with limited hardware capability can access feature rich information or data.

Generally, the server 104 and the client device 106 include a central processing unit, a memory (a primary and/or secondary memory unit), an input interface for receiving data, an input interface for receiving input signals from one or more input devices (for example, a keyboard, mouse, etc.), and an output interface for communications with an output device (for example, a monitor). In general, it should be understood that the server 104 and the client device 106 could include hardware objects developed using integrated circuit development technologies, or the combination of hardware and software objects that could be ordered, parameterized, and connected in a software environment to implement different functions described herein. Also, the hardware objects could communicate using electrical signals, with states of the signals representing different data.

It should also be noted that the server 104 and the client device 106 generally execute application programs resident at the server 104 and the client device 106 under the control of an operating system. Application programs, such as the server browser 108 and the client browser 110, may be stored on memory within the server 104 and the client device 106 and may be provided using machine language instructions or software with object-oriented instructions, such as the Java programming language. However, other programming languages (such as the C++ programming language) could be used as well.

As an example, the client browser 110 may reside on the client device 106, which may be an electronic device including any of a personal computer (PC), wireless telephone, personal digital assistant (PDA), hand-held computer, network appliance, and a wide variety of other types of electronic devices that might have navigational capability (e.g., keyboard, touch screen, mouse, etc.) and an optional display for viewing downloaded information content. Furthermore, the client device 106 can include any type of device that has the capability to utilize speech synthesis markups such as W3C (www.w3.org) Voice Extensible Markup Language (VoiceXML). One skilled in the art of computer systems will understand that the example embodiments are not limited to any particular class or model of computer employed for the client device 106 and will be able to select an appropriate system.

To provide an exemplary illustration, assume that a PDA hosts a client browser 110, a PC hosts the server browser 108, and the PDA and PC are both connected to an Ethernet network. Then, the client browser 110 and the server browser 108 could perform information transactions over the Ethernet network. Such transactions would utilize Ethernet or similar IEEE 802.3 protocols. In this example, the client and server browsers communicate over a wired network. The communications might also include a wireless network such as a local area wireless network (LAWN) or wireless local area network (WLAN). Moreover, the communications might include wireless networks that utilize other known protocols and technologies such as Bluetooth, wireless application protocol (WAP), time division multiple access (TDMA), or code division multiple access (CDMA).

Referring again to FIG. 1, the client browser 110 can send a request for information to the server browser 108. The client browser 110 may include an event translator 114 to convert a request/response protocol, such as an HTTP request, from the client browser 110 (e.g., WML, XHTML, cHTML, etc.) to an event that the server browser 108 recognizes. The translation process could include event information, content information, and the context of the event such that transactions between the client browser 110 and the information source 102 (e.g., HTML form submission) are preserved.

Information content from the information source 102 is retrieved and can be tailored for use on the client browser 110 by the server browser 108. Alternatively, the server browser 108 may retrieve the information content and send the information content to the client browser 110, which itself tailors the information appropriately for viewing. Content transformations may be necessary since the requested information content (e.g., a webpage) could have been initially designed for viewing on a large screen of a PC, rather than on a limited screen size of a handheld device. As a result, either the server browser 108 or the client browser 110 can perform information content transformations or apply device specific style sheets to aid in presentation (e.g., display or voice) and navigation (e.g., keyboard, touch screen, or scrolling), and perform content grouping for electronic devices that accepts data in limited quantities.

To deliver these capabilities, the server browser 108 or client browser 110 may include modules (not shown) including a user agent, cookie handler, QDOM, script executor, normalizer, and serializer, for example. Additional information pertaining to information content transformation or customization is included in U.S. Pat. No. 7,072,984, entitled “System and Method for Accessing Customized Information Over the Internet Using a Browser for a Plurality of Electronic Devices,” U.S. patent application Ser. No. 10/280,263, entitled “System and Method for Displaying Information Content with Selective Horizontal Scrolling,” and U.S. patent application Ser. No. 09/843,036, entitled “System and Method for Adapting Information Content for an Electronic Device,” the contents of each of which are incorporated herein by reference as if fully set forth in this description.

The terms “transform” and “transformation”, in the context of this application, are used to describe a process which may be implemented using computer hardware or software, to transcode, modify, update, replace, adapt, alter, convert, turn into, re-form, regenerate, rearrange, reshape, amend, and/or otherwise change information content.

### 2. HTML AND EMBEDDED SCRIPTING LANGUAGE COMMANDS

Information content received by the client browser 110 may comprise a web page. A web page comprises one or more browser commands written in a markup language, such as HTML. Specifically, HTML browser commands comprise one or more HTML elements. An HTML element comprises at least one tag, and may comprise a start tag, content, and an end tag. A start tag is of the form <tag [attrib1=“value”, [attrib2=“value2” . . . ]>, where tag is the HTML command to be executed, and attrib1 and attrib2 are optional attributes that modify and/or provide information about the HTML command. The content starts after the start tag. End tags delimit the end of the content and are typically denoted as </tag>.

One example of an HTML element is an anchor element to provide a hypertext link as information content. For example, to provide a link to the Novarra home page and display the word “Novarra”, an anchor element is used. An example HTML element that provides the link and display is an anchor (or “a”) element shown below:

<a href=“http://www.novarra.com”>Novarra</a>

The start anchor tag requires a Hypertext Reference (HREF) attribute with a value of the reference to be used. In this example, the reference is the Novarra web page, referred to by the Uniform Resource Locator (URL) of http://www.novarra.com. The end anchor tag is “</a>”. Many other HTML elements and tags exist and are well known to those of skill in the art.

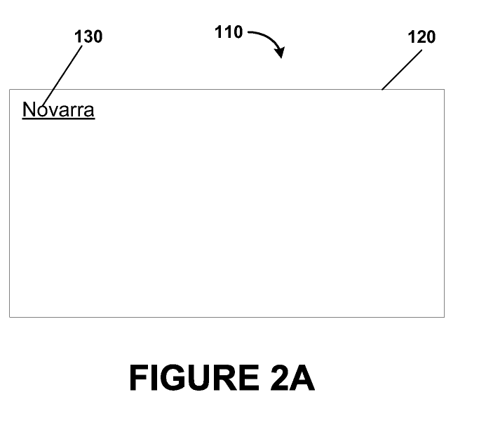

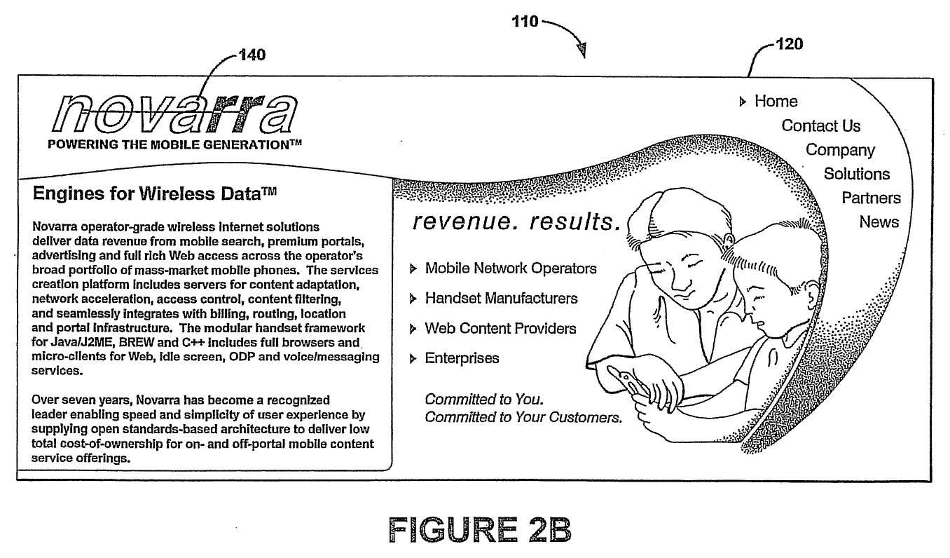

FIGS. 2A and 2B show example conceptual displays of a web page and web page elements of a browser window of the client device. FIG. 2A shows an example browser window 120 displaying a content 130 of the example HTML anchor element with a content of “Novarra” that provides a link to the Novarra home page. Upon receipt of one or more HTML browser commands, the client browser 110 is operable to execute the one or more HTML browser commands, render one or more HTML elements in the one or more HTML browser commands, and display the rendered HTML elements in the browser window 120 to the user of the client browser 110. The rendered HTML element may include the content of the HTML element. FIG. 2A shows a rendered HTML element in browser window 120 as the content 130 of the example HTML element.

FIG. 2B shows a web page displayed as a result of clicking on the content of an example HTML anchor element. Specifically, FIG. 2B shows the browser window 120 of the client browser 100 displaying the web page 140. Once the client browser 110 has rendered an HTML element, a user of the client browser 110 may click on the content 130 of the HTML element. If the HTML element comprises a reference attribute, then once the user clicks on the content 130, the client browser 110 responsively requests the transmission, if needed, of the reference specified in the reference attribute. Then, the client browser 110 may receive, render, and display the reference.

As an example, if the user of the client browser 110 clicked on the content 130 of the example HTML element displayed in FIG. 2A, then the client browser 110 may determine that the reference is the http://www.novarra.com URL and responsively request the transmission of the reference. Once the client browser 110 receives the transmitted reference, the client browser 110 executes the browser commands of the reference and renders the HTML elements of the reference. Then, the client browser 110 displays the rendered HTML elements of the reference in browser window 120. As shown in FIG. 2B, the web page 140 is the display of the HTML elements of the http://www.novarra.com reference.

Information content received by client browser 110 may comprise one or more scripting commands. A scripting command is a direction to a software application, such as a web browser. Scripting commands directing web browsers may be embedded within a web page to provide custom or additional functionality. Table 1 shows a web page with HTML browser commands and JavaScript scripting commands embedded within the web page.

TABLE 1

```
<html>
<body>
<script language=javascript>
    // the scripting command below is in the JavaScript language
    document.write(“JavaScript functionality”);
</script>
</body>
</html>
```

The web page begins with an “html” start tag of an html element, indicating to the web browser that the web page is written in HTML. The “body” start tag of a body element informs the web browser where the main portion, or body, of the web page begins. The “script” start tag of a script element instructs the web browser that there are scripting commands embedded within the web page. The language attribute of the script start tag specifies that the scripting commands are written in the JavaScript scripting language. The line beginning with “//” is a comment in the JavaScript scripting language. The “document.write” command of the JavaScript scripting language instructs the web browser to display text. In the example shown in Table 1, the text is “JavaScript functionality”. The “</script>”,“</body>”, and “</html>” end tags respectively close the script, body, and html elements of the web page.

If a web browser does not support the scripting language specified in the “script” tag, the functionality provided by the scripting commands may not be provided to the user of the web browser. A web browser may not support a scripting language if the computing device upon which the web browser is executing does not have a scripting engine. A scripting engine is software required to interpret and execute the scripting language. Further, the processing power and/or memory of the computing device may be insufficient to execute the scripting engine. If a scripting command is not executable by the web browser, the web browser may not display all of a web page. For the example web page shown in Table 1, if a web browser does not have a scripting engine for JavaScript, the web browser may not display the “JavaScript functionality” text.

### 3. THE nScript APPLICATION PROGRAMMING INTERFACE (API)

In one embodiment of the present application, the server browser 108 may replace one or more scripting commands in information content with one or more browser commands executable on the client browser 110. The scripting commands may not be executable on the client browser 110. Preferably, the browser commands are written using the nScript application programming interface (API). The nScript API comprises at least the nScript API functionality specified herein and an “nScript browser command” is an HTML browser command modified to provide any part of the functionality of nScript specified herein. One or more nScript browser commands may enable the client browser 110 to perform common operations that would otherwise be performed by executing at least one scripting command.

The nScript API may extend HTML by providing one or more nScript browser commands to interface with and utilize RFSE 112. The RFSE 112 supports the execution of the nScript browser commands by providing one or more scripting engine functions to the client browser 110. The client browser 110 may execute an nScript browser command, at least in part, by executing one or more scripting engine functions of RFSE 112. However, it is to be understood that the RFSE 112 may entail more functionality than described herein, including providing functionality that allows client browser 110 to execute all commands written in a scripting language, such as JavaScript 1.5 as specified by ECMA International, ECMA Script Language Specification, Edition 3 Final, Mar. 24, 2000.

As shown in FIG. 1, the RFSE 112 is part of the client browser 110. The RFSE 112 may be executable on a wide range of client devices 106, including client devices 106 with relatively small amounts of computer processing power and memory aboard

The nScript API provides an nScript markup structure which may be used to define a group of related items, as well as each item in the group of related items. The nScript API provides a suite of nScript functions for processing groups of related items. The nScript API provides for handling (i.e., supporting) events generated by a client browser. The events generated by a client browser may be handled using one or more nScript functions.

The nScript API supports external control of a web page, which is a command from a user-selectable control; e.g., a button or key of a user interface. The nScript API also supports internal control of a web page, which are actions taken by a web browser that are not directly related to a user-selectable control.

In an embodiment of the invention, information content may be written that includes one or more nScript browser commands to create information content intended to be used and/or displayed on the client device 110. In this embodiment, information content written using nScript browser commands is designed specifically for use and/or display on the client device 106 and/or the client browser 110. Examples of information content in this embodiment include, but are not limited to: (a) web pages, including portal pages, designed for display on the client device 106 and/or with client browser 110, (b) client browser-based software applications for the client device 106, and (c) portions of software applications and/or web pages termed “widgets” usable on client device 106 and/or with client browser 110.

Information content written with nScript browser commands may be tested with a testing web browser, where the testing web browser may not be client browser 110. A testing web browser may be used for the ease and convenience of creating and/or testing web content written using nScript browser commands. The testing web browser may be used as well to ensure compatibility and/or equivalence between the information content written using nScript browser commands displayed on the client browser and the information content displayed using the testing web browser.

a. nScript Markup Structures

The one or more nScript browser commands may be arranged as an nScript markup structure. An nScript markup structure defines a group of items, as well as each item in the group of items. The nScript markup structure comprises one or more HMTL division (<div>) elements. Each HTML division element contains an attribute that identifies the element as part of the nScript markup structure.

Table 2 shows an nScript markup structure comprising four HTML division elements, each with a “class” attribute identifying the division element as either a “NovarraGroup” or a “NovarraGroupItem.” A division element with a class of “NovarraGroup” defines a group in an nScript markup structure, and a division element with a class of “NovarraGroupItem” defines an item in the group in the nScript markup structure. Note that group items may be defined using a class attribute of other HTML elements, such as the image (<img>) elements shown below in Table 4. A division element that defines a group of item or a item in the group of items may specify a name or identifier for the group or group item using an “id” attribute of the division element.

TABLE 2

```
<div class=“NovarraGroup” id=“myGroup”>
    <div class=“NovarraGroupItem” id=“tab_page_1”>
    </div>
    <div class=“NovarraGroupItem” id=“tab_page_2”
    style=“display: none”>
    </div>
    <div class=“NovarraGroupItem” id=“tab_page_3”
    style=“display: none”>
    </div>
</div>
```

The nScript markup structure in Table 2 defines a group of items named “myGroup” with three group items named “tab_page_1,” “tab_page_2,” and “tab_page_3.” The first division element in Table 2 defines the group of items, as the class attribute of the first division element is “NovarraGroup,” and specifies the name of myGroup for the group of items. The second division element in Table 2 defines an item in the myGroup group of items, as the class attribute for the second division element is “NovarraGroupItem”, and specifies the name of “tab_page_1” for the group item. Further, the third and fourth division elements of Table 2 respectively define the “tab_page_2” and “tab_page_3” items in the myGroup group of items.

A style attribute of the division element may be specified to indicate display information to the client browser 110. If no style is specified, the client browser 110 may initially display the element. Table 2 indicates that the tab_page_1 item has no style attribute specified, and so is initially made visible (i.e., displayed) by client browser 110. Table 2 also indicates that the items tab_page_2 and tab_page_3 both have a style attribute of “display=none.” Responsive to the style attribute of “display=none”, the client browser 110 initially does not display the group items tab_page_2 and tab_page_3. Tab_page_2 and tab_page_3 are examples of hidden objects (i.e., they are not displayed initially).

The nScript API provides for a series of specialized or “built-in” groups for processing commonly displayed groups of items. For example, a built-in group for pictures is provided as a part of nScript. The nScript API provides a built-in group for favorite links as designated by the user of the browser group of URLs, as well as a built-in group for historical links, as the links most recently visited the user of the browser. It is to be understood that other such built-in groups are possible as well.

To create a group of pictures to be displayed as a list, the following built-in group within an HTML division element may be used:

<div class=“NovarraBuiltInGroup” id=“NovarraPictures” type=“List”>

The items in a built-in group may be specified as division elements as shown in Table 2.

b. nScript Functions

The nScript API provides a suite of nScript functions to process control the display of a group item within the group. Each function in the suite of nScript function may operate on an item in a group of related items and/or the group of related items. Preferably, the nScript function to be invoked is specified as part of an HTML anchor element. That is, the invocation of an nScript function is specified as Document Object Model (DOM) Level 0 inline element.

For example, the following nScript browser command invokes a “setGroupNext” nScript function to display the next item in a group named ‘NovarraPictures’ when the user clicks on a computer mouse:

<a onclick=“setGroupNext(‘NovarraPictures’)” href=“#”>

The syntax of an nScript browser command, including the invocation of an nScript function, may be the same as or similar to the syntax of a scripting language command, such as a JavaScript command. Use of the same (or similar) syntax for both nScript browser commands and scripting language commands may aid the testing of web pages on testing web browsers before testing and/or deploying web pages on client browser 110.

An exemplary suite of nScript functions is described in Table 3:

TABLE 3

| Name of nScript Function | Description of nScript Function |
|---|---|
| setGroupVisible(groupId, target, newFocus) | This function finds the block with attribute |
| | id equal to target in the specified group and |
| | makes it visible, while all other elements in |
| | the group are set invisible. If the newFocus |
| | parameter is set, this function will also set |
| | the focus to an element whose id it matches. |
| setGroupNext(groupId, newFocusPrefix) | This function iterates through all of the |
| | group items in the specified group, making |
| | each group item visible in turn. Each call to |
| | this function will make the successive entry |
| | the sole visible member. This function will |
| | continuously loop through all group items. |
| | The optional parameter newFocusPrefix can |
| | be used to find the element to set as focus. It |
| | takes the prefix value, appends the index of |
| | the currently visible element and sets the |
| | matching element in the current item as |
| | focus. This means that elements that are |
| | intended to be used with this function should |
| | be given id values that differ only by a |
| | numerical suffix (starting at zero and |
| | increasing in count). |
| setGroupPrev(groupId, newFocusPrefix) | This function is identical to setGroupNext, |
| | but operates in the reverse direction. |
| cycleGroup(groupId, cycleTime, | This function will call setGroupNext( ) every |
| newFocusPrefix) | cycleTime milliseconds. Invoking this |
| | function with a cycle time less than or equal |
| | to 0 will stop the timer. |
| horizGroupNav(groupId, newFocusPrefix, | This function is used with the onKeyDown |
| event) | event. When a left arrow key or equivalent |
| | is pressed on the currently focused item, this |
| | function invokes the setGroupPrev( ) |
| | function. When the right arrow key or |
| | equivalent is pressed, this function invokes |
| | the setGroupNext( ) function. |
| updateGroup(groupId, src, newFocus) | This function inserts the content referenced |
| | by the src attribute in block identified by the |
| | groupId. If the newFocus parameter is set, |
| | this function will also set the focus to an |
| | element whose id it matches. |
| deleteGroupItem(groupId, newFocus) | This function will delete the currently |
| | focused item from the group. If the |
| | newFocus parameter is set, this function will |
| | also set the focus to an element whose id it |
| | matches. |

It is to be understood that the suite of nScript functions may include more or fewer functions and the nScript functions may include other functionality. Other functionality may include, but is not limited to, the ability to change image positions, form manipulation operations, additional user controls, automatic data updates, and interacting with external data sources.

Form manipulation operations may include validating form data and/or automatically completing user forms. Additional user controls may comprise user controls and/or additional focus operations. User controls may comprise controls such as menus, editors, trees, and calendars. Additional focus operations may comprise providing more information and/or change the display of an item when a user places the focus (a position of interest to a user as indicated by mouse, keyboard navigational control, or other indicating device) over a group item. Automatic data updates may provide for automatic updates of information, such as news, weather, sports scores, and stock quotes. Interacting with external data sources may comprise providing one or more functions to interact with external data sources, such as Google Maps.

c. Event Handling with the nScript API

Each nScript function in the suite of nScript functions may be executed when triggered by an event generated in an event-driven system. An event-driven system is a software system that may generate one or more events in response to actions that occur within the event-driven system. An example event-driven system is client browser 110. Two example events are user input to the client browser 110 or the completion of an operation (e.g., displaying a web page) by the client browser 110. Each event may relate to the information content as a whole and/or to a specific element of the information content. The generation of an event may be performed by software within the event generator 114 or by other software within the client browser 110.

As an example of event generation, a default event is generated when the user clicks on or otherwise chooses an element displayed by a web browser, such clicking on the displayed “Novarra” content when the example HTML element is rendered:

<a href=“http://www.novarra.com”>Novarra</a>

In response to the default event, the web browser will load the web page specified as the reference as described above.

Specifically, one or more events may be generated by the client browser 110 either autonomously by the client browser 110 or due to an action by a user of the client browser 110. Two examples of events generated autonomously by the client browser 110 are an “onload” event and an “onshow” event, each of which are generated when a web page is loaded or made visible, respectively, by the client browser 110. Three examples of events generated by user action are: an “onfocus” (i.e., focus) event generated when the user of the client browser 110 focuses on (i.e., selects) an element of a web page by use of a keyboard, mouse, touch screen, or other selection device; an “onkeypress” and/or an “onkeydown” event generated when the user presses a key while an element of a web page is displayed by the client browser 110; and an “onclick” event generated when the selection device is used to click on an element displayed by client browser 110. The nScript API provides support for at least the default, onload, onshow, onfocus, onkeypress, and onkeydown events.

The nScript API provides the ability to handle events using nScript event handlers. The following anchor tag is an example of an nScript event handler:

<a onclick=“setGroupNext(‘NovarraPictures’)” href=“#”>

The anchor tag specifies an nScript event handler by specifying the name of an nScript function, to handle an event. In the example anchor tag, the setGroupNext nScript function is specified to handle the onclick event. Then, if an onclick event is generated for the element comprising the example anchor tag, the client browser 110 will execute the setGroupNext nScript function. The setGroupNext nScript function will make a next item in the group of items visible. The items may be ordered as specified in the web page and/or may be ordered according to an “id” attribute of an element in the nScript markup structure specifying the element.

The next item in the group of items may be an element with the “id” that succeeds a current item. For example, suppose a group of three items are specified, where the items are specified with id attributes of “item1”, “item2”, and “item3”, respectively and the current item is item2. In this example, the “id” of the item that succeeds item2 in the group of items is item3. If the current item is a last item in a group of items, the succeeding item may be the first item in the group of items; in this example, if the current item is item3, the succeeding item is item1.

Similarly, the previous item in the group of items may be an item with the “id” that precedes the current item; in this example, the “id” of the item that precedes item2 in the example group of items is item1. If the current item is a first item of a group of items, the preceding item may be the last item in the group of items; in this example, if the current item is item1, the preceding item is item3.

An event handler may specify that a plurality of nScript functions are to be used to handle an event. For example, the following nScript event handler calls both the setGroupVisible and updateGroup nScript functions to handle the onclick event:

<a onclick=“setGroupVisible( );updateGroup( )” href=“#”>

The one or more nScript browser commands may be embedded within a dynamic web page, which is a web page comprising one or more nScript browser commands to perform common operations on the information content. As an example, one or more nScript browser commands may enable a dynamic web page to provide a plurality of tabs. Each of the plurality of tabs may correspond to part or all of a web page; therefore, the selection by the user of a tab in the plurality of tabs allows display of part or all of a web page corresponding to the selected tab.

Another example of a dynamic web page provides a plurality of folders. Each folder in the plurality of folders may contain a group of folder items, wherein each folder item may be a URL, an image file, a sound file, a text file, or other data source. A user may either open or close a folder on a dynamic web page. If a folder within the plurality of folders is open, the group of folder items is displayed to the user. If a folder within the plurality of folders is closed, the group of folder items is not displayed to the user. The one or more nScript browser commands enable the actions of the folders, including their opening and closing. It is to be understood that other dynamic web pages than those described herein may be written using one or more nScript browser commands.

d. External Controls

The nScript API enables web pages to support external and internal controls. The nScript API supports external control of a web page, which is a command from a user-selectable control (e.g., a button or key of a user interface). The nScript API also supports internal control of a web page, which are actions taken by a web browser that are not directly related to a user-selectable control.

More specifically, a web page supports an external control when (1) the web page specifies one or more user-selectable controls, such as buttons, arrows, or other similar elements of a user interface, and (2) responsive to a user selecting a user-selectable control, the web page changes of the display of the web page.

Table 4 shows an example portion of a web page that supports external controls allowing a user to cycle through the items in the group of ‘cape_images.’ The user can cycle through the items by clicking on left and right buttons displayed on client browser 110, wherein the left and right buttons specified in the example of Table 4 act as user-selectable controls. The left and right buttons are displayed by rendering image elements specifying “picleft.png” and “picright.png” images, respectively. Note that HTML image elements do not require end tags.

```
TABLE 4
<table cellspacing=″0″ cellpadding=″0″ rows=″1″ cols=″3″>
<tr>
    <td><a href=″#” onClick=setGroupPrev(‘cape_images’)″><img
src=″picleft.png″></a></td>
    <td><a href=″#” onClick=setGroupPrev(‘cape_images’)″><img
src=″picright.png″></a></td>
</tr>
</table>
<br>
<div class=″NovarraGroup″ id=″cape_images″>
    <img class=″NovarraGroupItem″ id=”cape0” src=″cape1.jpg″>
    <img class=″NovarraGroupItem″ id=”cape1” src=″cape2.jpg″
style=″display: none″>
    <img class=″NovarraGroupItem″ id=”cape2” src=″cape3.jpg″
style=″display: none″>
</div>
```

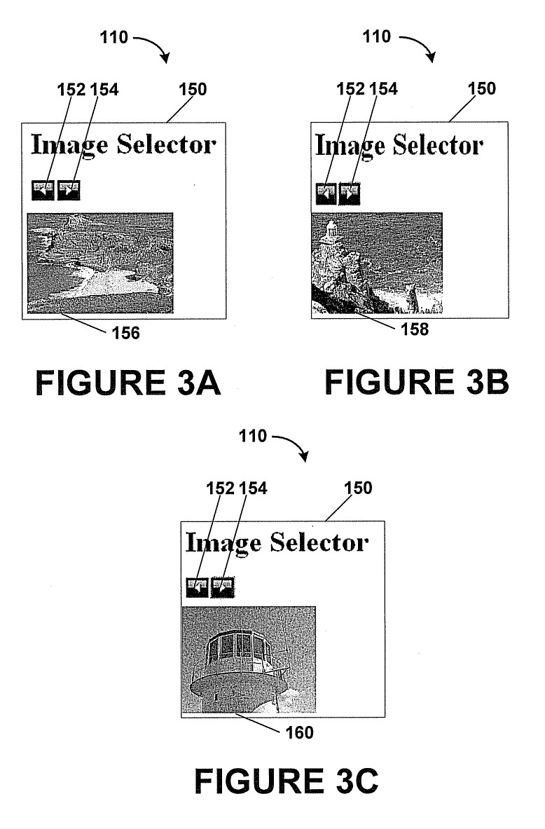

FIGS. 3A, 3B, and 3C each show a client browser window 150 of a client browser 110 after executing the nScript browser commands shown in Table 4. A left button 152 and a right button 154 are displayed in the browser window 150 of the client browser 110. In FIG. 3A, a first image 156 is displayed in the browser window 150. In FIG. 3B, a second image 158 is displayed in browser window 150. In FIG. 3C, a third image 160 is displayed in browser window 150.

The first image 156, second image 158, and third image 160 each correspond to a group item of the cape_images group, where the corresponding group item is an image element with an id attribute of “cape0”, “cape1”, and “cape2”, respectively. Initially, only the cape0 group item is displayed, as the cape1 and the cape2 group items are hidden items. The cape1 and the cape2 group items are hidden items as they have a style attribute of “display: none”.

The left button 152 and the right button 154 allow a user of the client browser 110 to navigate between images in the group and control the visibility of the items within the group. Table 4 indicates that the anchor tag for the left button comprises the reference of “onClick=setGroupPrev(‘cape_images’)”. This reference establishes a setGroupPrev nScript function as an event handler for handling the default event for the left button 152. Similarly, the reference “onClick=setGroupNext(‘cape_images’)” establishes the setGroupNext nScript function as an event handler for handling the default event for the right button 154.

As an example, assume the first image 156 has been presented to the user in the browser window 150, as shown in FIG. 3A, and the user then clicks on the left button 152, which generates a default event. The default event for the left button 152 is handled by the setGroupPrev nScript function, which responsively makes the previous item in the group visible. In this example, as the first group item in the cape_images group is the current item, the previous item in the group is the last item of the group; in this example, the last image of the group is the third image 160. The setGroupPrev nScript function also affects the other items in the group—e.g., the first image 156 and the second image 158—by making the other items in the group invisible; i.e., does not display the other items in the group. FIG. 3C shows the display of the third image 160 as made visible in browser window 150.

As a second example, again assume the first image 156 has been presented to the user, as shown in FIG. 3A, and then the user clicks on the right button 154, which generates a default event. The default event for the right button 154 is handled by the setGroupNext nScript function, which responsively makes the next item in the group visible. In this example, as the first group item in the cape_images group is the current item, the next item in the group is the second group item; in this example, the next item of the group is the second image 158. The setGroupNext nScript function also makes other items in the group (e.g., the first image 156 and the third image 160) invisible. FIG. 3B shows the display of the second image 158 as made visible in browser window 150.

Similar functionality to the example shown in Table 4 for keyboard navigation may use a horizGroupNav nScript function as an event handler. The horizGroupNav nScript function (described in Table 3 above) invokes the setGroupPrev nScript function, when a left arrow key is pressed, or the setGroupNext nScript function, when a right arrow key is pressed. An example nScript browser command is shown below which assigns the horizGroupNav nScript function to handle the onkeydown event for the cape_images group defined in Table 4 above:

<a onkeydown=“horizGroupNav(‘cape_images’,‘cape’,event)”></a>

A cycleGroup nScript function may be invoked to control the visibility of the group of related images based, at least in part, on the expiration of a timer. As described above in Table 3, the cycleGroup nScript function may invoke the setGroupNext nScript function to display an image in a specified set of images. The cycleGroup nScript function may set a timer to expire after a period of time, wherein the period of time is specified by the invocation of the cycleGroup nScript function. When the timer expires after the period of time, the cycleGroup nScript function may invoke the setGroupNext nScript function to display the next image in the group and may reset the timer to expire after the period of time. The cycleGroup nScript function repeats the steps of (i) invoking the setGroupNext nScript function and (ii) resetting the timer to the period of time upon the expiration of the timer, until the cycleGroup nScript function is invoked with a timer value less than or equal to 0.

An example nScript browser command is shown below which invokes the cycleGroup nScript function when an onload event is generated upon loading a web page. The cycleGroup nScript function handles the event of loading a web page containing the cape_images group (defined in Table 4) by displaying each image for 5000 milliseconds (5 seconds):

<a onload=“cycleGroup(‘cape_images’,5000, ‘cape’)”></a>

e. Internal Controls

Internal controls are actions taken by a web browser that are not directly related to an action by a user. Some user interface designs may require a markup element that provides an event handler, such as an nScript markup element, to change visibility along with a visible element. There are many uses for such markup elements, such as in tab start pages, folders, or changing whole forms. For example, when a user selects an element of a web page, the web browser may make the selected element visible. However, one or more internal controls of the web browser may make one or more other elements of the web page invisible.

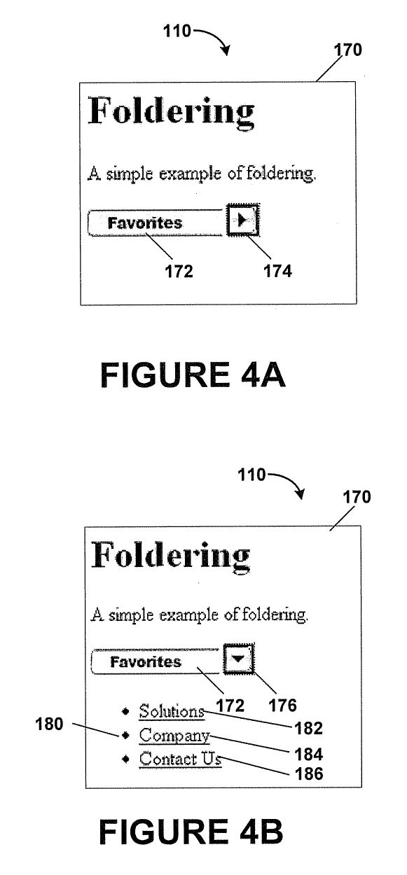

Table 5 provides an example portion of a web page supporting an internal control. FIGS. 4A and 4B each show a client browser window 170 of the client browser 110 after executing the nScript browser commands shown in Table 5.

```
TABLE 5
<div class=“NovarraGroup” id=“bookmarks”>
  <div class=“NovarraGroupItem” id=“bm_closed”>
    <img src=“favorites.png”>
    <a id=“bm_closed_foc” href=“
setGroupVisible(‘bookmarks’,‘bm_open’,‘bm_open_foc’)”><img
src=“sign_closed.png”></a>
  </div>
  <div class=“NovarraGroupItem” id=“bm_open” style=“display: none”>
    <img src=“favorites.png”>
    <a id=“bm_open_foc” href=“
setGroupVisible(‘bookmarks’,‘bm_closed’,‘bm_closed_foc’)”> <img
src=“sign_open.png”></a>
    <ul>
      <li><a
      href=“www.novarra.com/Solutions/index.htm”>Solutions</a>
      <li><a href=“www.novarra.com/Company.htm”>Company</a>
      <li><a href=“www.novarra.com/Company2.htm”>Contact Us</a>
    </ul>
  </div>
</div>
```

The example portion of a web page creates a “bookmarks” group with a “bm_closed” group item and a “bm_open” group item. Initially, the client browser displays the bm_closed group item, as the bm_open group item is a hidden item, as specified with a style attribute of “display: none”. The content of the bm_closed group item comprises a closed content image element and a closed content anchor tag. The closed content image element comprises a favorites image, with a source attribute of “favorites.png”. The closed content anchor tag comprises an event handler for a default event. The event handler for the default event is a setGroupVisible nScript function, wherein the setGroupVisible nScript function handles the default event by making the bm_open group item visible. As described above in Table 3, the setGroupVisible nScript function acts as an internal control and makes all other group items (e.g., the bm_closed item) invisible.

FIG. 4A shows the client browser window 170 of the client browser 110 displaying the content of the bm_closed group item. The content of the bm_closed item comprises the favorites image 172 and the sign closed image 174, as displayed in the client browser window 170. If a user of the client browser 110 clicks on the sign closed image 174, the default event is generated for the bm_closed group item. The setGroupVisible nScript function handles the default event and makes the bm_open item visible and makes the bm_closed item invisible.

FIG. 4B shows the client browser window 170 of the client browser 110 displaying the content of the bm_open group item. The client browser window 170 may display the content of the bm_open group item in response to the user clicking on the sign closed image 174 shown in FIG. 4A. The content of the bm_open item comprises an open content image element, an open content anchor tag, and a bookmarks list. The open content image element comprises the favorites image used in the closed content image element. FIG. 4B shows the favorites image 172 indicated for this element.

The open content anchor tag comprises a sign open image, as content specified by an image element with a source attribute of “sign_open.png”, and an event handler for the default event. FIG. 4B shows the browser window 170 displaying the sign open image 176. The event handler for the default event is a setGroupVisible nScript function, wherein the setGroupVisible nScript function handles the default event by making the bm_closed group item visible.

If the bm_open group item is displayed and the user clicks on the sign open image 176, a default event is generated for the bm_open group item and the setGroupVisible nScript function handles the default event. The setGroupVisible nScript function makes the bm_closed group item visible and makes all other group items (e.g., the bm_open group item) invisible. FIG. 4A shows the browser window 170 with the bm_closed group item visible, as indicated by displaying the sign closed image 174, and the bm_open group item invisible.

In the example web page of Table 5, the bookmarks list has three bookmarks: a Solutions bookmark, a Company bookmark, and a Contact Us bookmark. Returning to FIG. 4B, the browser window 170 displays the bookmark list 180 with the Solutions bookmark 182, the Company bookmark 184, and the Contact Us bookmark 186. If a bookmark is selected by the user, the client browser 110 will display the contents of the related link to the displayed bookmark. For example, selecting the Contact Us bookmark 186 will cause the client browser to retrieve and display the contents of the http://www.novarra.com/Company2.htm link of the Contact Us bookmark 186.

By providing support on the client device 106 for external and internal controls, the nScript API requires less communication between the server 104 and the client device 106 than required for a client browser 108 that does not support the nScript API. The support of internal and external controls in the client browser 110 via nScript allows the client browser 110 to render changes to elements of web pages that would typically be rendered by a scripting engine. If the client browser 110 were unable to render changes to the elements of web pages, the client browser 110 would have to request that the server 104 process the changes to the web page through server browser 108, and transmit the changed web page to the client device 106. Therefore, providing support on the client device 106 for external and internal controls reduces the communication between the server 104 and the client device 106.

### 3. An EXAMPLE SERVER

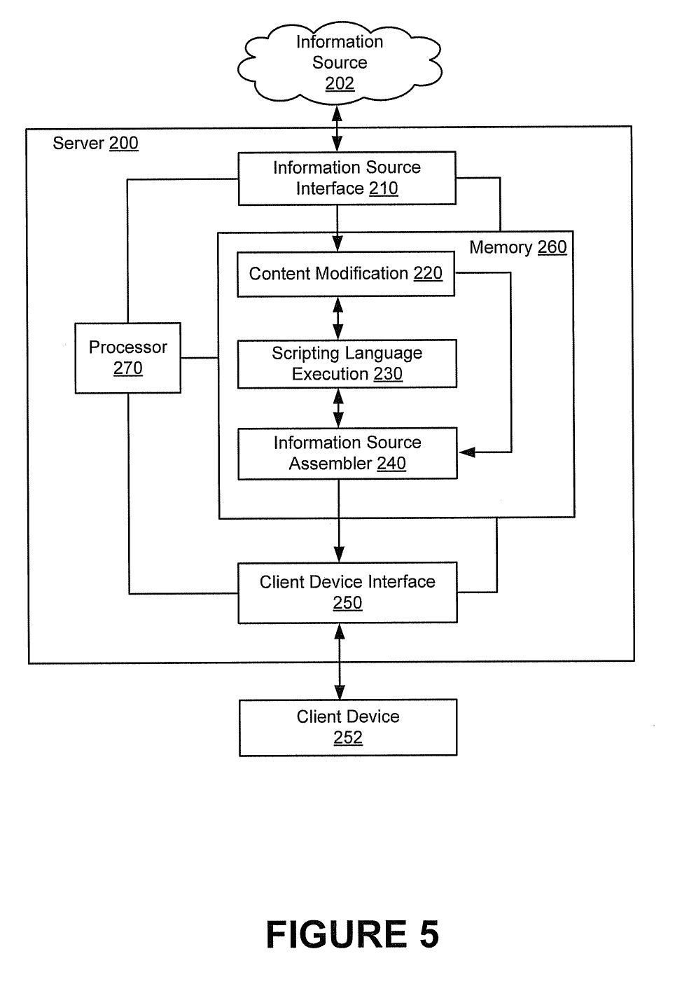

FIG. 5 is a block diagram of a server 200. The server 200 includes an information source interface 210 and a client device interface 250 coupled to a memory 260 and a processor 270. The information source interface 210 provides a communication interface between the server 200 and one or more information sources 202. The client device interface 250 provides a communication interface between the server 200 and one or more client devices 252. While shown separately in FIG. 5, the information source interface 210 and client device interface 250 may be implemented as one interface.

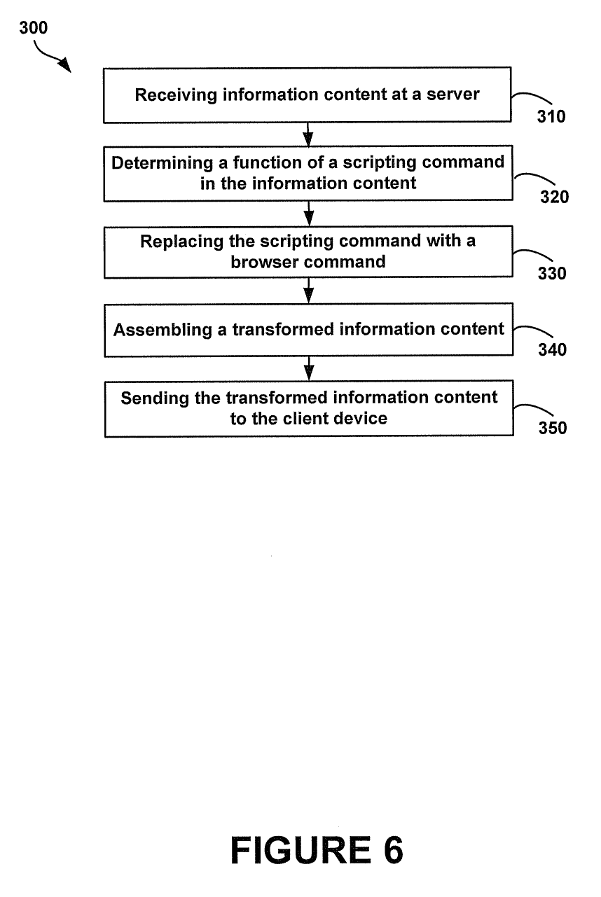

The processor 270 comprises one or more computer processors with at least sufficient processing power to execute the software that performs the method depicted in FIG. 6. The memory 260 comprises one or more storage devices, which may comprise volatile and/or non-volatile memory, with at least sufficient storage capacity to store the software and any additional memory required by the software to perform the method depicted in the flowchart of FIG. 6.

The processor 270 accesses the memory 260 to execute software or program instructions that enable operation of a content modification module 220, a scripting language execution module 230, and an information source assembler module 240. The content modification module 220 is a software application that is executable by the processor 270 to transform an information content to an equivalent transformed information content that can be displayed on client device 252. In particular, the content modification module 220 is operable to transform an information content containing at least one scripting command to an equivalent transformed information content containing at least one browser command executable by a client browser resident on client device 252. The scripting language execution module 230 is a software application that is executable by the processor 270 to execute one or more scripting language commands to render a web page. The information source assembler module 240 is a software application executable by the processor 270 to assemble an information source that can be displayed on client device 252 from inputs from the information source transformer 220 and the scripting language execution module 230.

### 4. A METHOD FOR PROCESSING INFORMATION CONTENT FOR DISPLAY ON A CLIENT DEVICE

FIG. 6 is a flowchart depicting example functional blocks of a method 300 of processing information content for display on a client device. It should be understood that each block in this flowchart and within other flowcharts presented herein may represent a module, segment, or portion of computer program code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of the described embodiments.

At block 310, the method 300 comprises receiving information content at a server. The information content comprises at least one scripting command written in a scripting language that is operable to be executed on a web browser. The at least one scripting command may be written in the JavaScript scripting language.

At block 320, the method 300 comprises determining a function of at least one scripting command within the information content. The method 300 determines the function of the at least one scripting command by examining keywords, patterns and/or structure of the at least one scripting command.

An examination of keywords and/or the structure in the at least one scripting command may indicate that the at least one scripting command may be replaced by at least one browser command. For example, one or more objects may be created using the JavaScript scripting language. In JavaScript, an object may be “a hidden object” (initially not rendered by a web browser) may be created by setting the “display.value” attribute of the object equal to “none.” Therefore, a keyword search for “display.value=none” may find a hidden object, which may then be replaced by one or more browser commands that create a similar hidden object. As another example, widely used scripting libraries, such as the Google Maps library, may be identified by searching for keywords such as “google.” Then, one or more browser commands may be used to replace one or more scripting commands that refer to a widely used scripting library.

A grammatical structure of and/or patterns within the at least scripting command may determine a function of the at least one scripting command. A scripting language interpreter (described in block 330 below) may determine the grammatical structure of the at least one scripting command. A pattern recognizer (described in block 330 below) may determine patterns within the at least one scripting command.

At block 330, the method 300 comprises replacing at least one scripting command with at least one substitute browser command, wherein the at least one substitute browser command has the function of the at least one scripting command as identified in block 320. Some examples of replacing scripting commands with substitute browser commands are: (1) replacing scripting commands that change the visibility of images based on external controls with the browser commands shown in Table 4 above; (2) replacing scripting commands for processing bookmarks with the browser commands shown in Table 5 above; and (3) replacing scripting commands that create hidden objects with browser commands similar to those shown in Table 2 above that create a similar hidden object. Preferably, the browser commands comprise at least one nScript browser command.

Replacing scripting commands with browser commands may be implemented by use of a database. The database may store one or more nScript browser commands and may retrieve the stored nScript browser commands in response to a database query. The database query may be written in a database query language or an information retrieval query language, such as Structured Query Language (SQL), SQL in Java (SQLJ), Common Query Language (CQL), and/or Object Query Language (OQL).

The stored nScript browser commands may comprise one or more template commands, wherein a template command requires additional processing after retrieval from the database before the template command can be used in an information element. Such additional processing may comprise, but is not limited to, inserting the name of a group of related items into the template command or inserting the name of an item in the group of related items into the template command.

The database query may be formulated by the server. The database query may comprise a portion or all of the scripting commands. The database query may comprise one or more keywords found in the information content. The database query may comprise information about the structure of the scripting commands. Information about the structure of the scripting commands may comprise some or all of the scripting commands.

Replacing scripting commands in an information content with substitute browser commands may involve use of a pattern recognizer. The pattern recognizer may recognize patterns in scripting commands in the information content and replace the recognized pattern of scripting commands with substitute browser commands.

Patterns of scripting commands within the information content may include naming conventions and/or references to standard software libraries. Naming conventions, may determine a pattern in the scripting commands. An example naming convention is the use of variable names of variables such as “visible” or “make_visible” within scripting commands for controlling the visibility of items. References to one or more standard software libraries may be a pattern within the scripting commands. For example, the pattern recognizer may determine a pattern in a reference to a standard software library providing Flash animation functionality within one or more scripting commands. The pattern recognizer may then replace the scripting commands that follow naming conventions and/or reference standard software libraries with substitute browser commands that perform the same function.

The pattern recognizer may recognize a pattern within scripting commands by examining one or more related browser commands of the information content as well. For example, the pattern recognizer may recognize a pattern of scripting commands that, perhaps in conjunction with related browser commands, that perform a common function or functions. The pattern recognizer may then replace the scripting commands and/or related browser commands with substitute browser commands that perform the same function(s). For example, a pattern may be recognized in scripting commands that control the visibility of a group of items, wherein the group of items were created with browser commands. In this example, the pattern recognizer may replace the scripting commands and/or related browser commands with substitute browser commands that create the group of items and/or control the visibility of the group of items.

Replacing scripting commands with substitute browser commands may be implemented by use of a scripting language interpreter. The scripting language interpreter may read in one or more scripting commands written in a scripting language, perform lexical analysis and/or parse the scripting commands to determine a grammatical structure for the scripting commands, and output one or more substitute browser commands having a same or similar grammatical structure to the grammatical structure of the scripting commands.

Lexical analysis of the scripting commands may comprise determining one or more tokens that correspond to each of the scripting commands. The tokens may be determined by categorizing the scripting commands according to one or more lexical rules of the scripting language. The lexical rules may describe textual patterns, such as the use of the character “=” to mean the term equals. An example token for the input “=” may be EQUALS.

A parse, or determination of a grammatical structure of the scripting commands may comprise using the tokens as input to a parser of the scripting language. A parser of the scripting language may parse the tokens based on categorizing the tokens according to one or more grammatical rules of the scripting language. The grammatical rules of the scripting language may define a grammar for the scripting language, such as determining the assignment of a value to a variable, if a variable is on the left hand side of an equals sign. In this example, the parser may have a grammatical rule that translates a string of tokens, such as VARIABLE(x) EQUALS VARIABLE(y), into a grammatical structure of an assignment of a value held in a variable y on the right hand side of the EQUAL token to a variable x on the left hand side of the EQUALS token. Once the grammatical structure of the scripting commands is determined, one or more substitute browser commands, preferably written in nScript, may be generated with the same (or similar) grammatical structure to replace the one or more scripting commands.

At block 340, the method 300 comprises assembling a transformed information content. The transformed information content may be assembled by initially copying the information content and then removing all scripting commands in the copied information content. At least one insertion position within the transformed information content may be determined for the one or more substitute browser commands and then the one or more substitute browser commands are inserted at the insertion position.

For example, suppose the information content comprises scripting commands S1, S2, and S3, wherein the scripting commands S1, S2, and S3 are embedded within a web page comprising HTML elements E1, E2, E3, E4, and that the scripting commands S1, S2, and S3 are invoked by HTML element E4 as shown in Table 6 below.

TABLE 6

```
<E1>
<E2>
      S1;
      S2;
      S3;
<E3> content for E3
<E4> content for E4 with scripting command invocation
</E4>
</E3>
</E2>
</E1>
```

Further suppose that element E5, written in nScript, is to be inserted at an insertion point within E4 to replace the scripting commands S1, S2, and S3 as well as the invocation of the scripting commands. In the transformed information content, the original information element is copied and then S1, S2, and S3 are removed. The insertion of E5 at an insertion point within E4 may separate a content of E4 into a first original content for E4 and a second original content for E4. Table 7 below shows the transformed information content:

TABLE 7

```
<E1>
<E2>
<E3> content for E3
<E4> first original content for E4
      <E5> content for E5 </E5>
      second original content for E4
</E4>
</E3>
</E2>
</E1>
```

At block 350, the method 300 comprises sending the transformed information content from the server to a client device. The server may send the transformed information content using client device interface 250.

### 5. CONCLUSION

Although the present application has been described using scripting command transformations including transformations of JavaScript commands, other types of scripting commands may be transformed in the same or similar manner as described above. For example, scripting commands written in languages such as JScript, VBScript, Visual Basic, and/or Tcl, among others, may be transformed. It should be understood that the programs, processes, methods and systems described herein are not related or limited to any particular type of computer or network system (hardware or software), unless indicated otherwise. Various types of general purpose or specialized computer systems may be used with or perform operations in accordance with the teachings described herein.

It should be further understood that this and other arrangements described herein are for purposes of example only. As such, those skilled in the art will appreciate that other arrangements and other elements (e.g., machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

In view of the wide variety of embodiments to which the principles of the present application can be applied, it should be understood that the illustrated embodiments are exemplary only, and should not be taken as limiting the scope of the present application. For example, the steps of the flow diagrams may be taken in sequences other than those described, and more or fewer elements may be used in the block diagrams. While various elements of embodiments have been described as being implemented in software, in other embodiments hardware or firmware implementations may alternatively be used, and vice-versa.

Note that while the present application has been described in the context of a fully functional server and client device system and method, those skilled in the art will appreciate that mechanisms of the present application are capable of being distributed in the form of a computer-readable medium of instructions in a variety of forms, and that the present application applies equally regardless of the particular type of signal bearing media used to actually carry out the distribution. For example, a computer usable medium can include a readable memory device, such as a hard drive device, CD-ROM, a DVD-ROM, or a computer diskette, having computer readable program code segments stored thereon. The computer readable medium can also include a communications or transmission medium, such as, a bus or a communication link, either optical, wired or wireless having program code segments carried thereon as digital or analog data signals. As such, the methods described herein may be embodied in a computer program product that includes one or more computer readable media, as described as being present within the server 104 or the client device 110.

The claims should not be read as limited to the described order or elements unless stated to that effect. Therefore, all embodiments that come within the scope and spirit of the following claims and equivalents thereto are claimed as the invention.

A portion of the disclosure of this patent document contains material which is subject to copyright protection. The copyright owner has no objection to the facsimile reproduction by anyone of the patent document or patent disclosure, as it appears in the Patent and Trademark Office file or records, but otherwise reserves all copyright rights whatsoever.

What is claimed is:

1. A method of processing information content for display on a client device, comprising:
receiving information content that includes a scripting command, wherein the scripting command is not executable on the client device;
determining a function of the scripting command;
in the information content, replacing the scripting command with a browser command, wherein the browser command is executable on the client device to perform the function of the scripting command; and
sending the information content to a client device.

2. The method of claim 1, wherein the browser command comprises an nScript browser command, wherein the nScript browser command is written using the nScript Application Programming Interface (API) and is executable on the client device.

3. The method of claim 2, wherein the nScript browser command comprises an anchor tag, wherein the anchor tag comprises an event handler.

4. The method of claim 1, wherein the scripting command is written in the JavaScript scripting language.

5. The method of claim 1, wherein the function of the scripting command comprises displaying a displayable item.

6. The method of claim 1, wherein the function of the scripting command comprises displaying a dynamic web page.

7. The method of claim 1, wherein the function of the scripting command comprises displaying a folder.

8. The method of claim 1, wherein:
the scripting command comprises a scripting command for handling an event at the client device, and wherein the browser command comprises an nScript browser command executable by the client device for handling the event at the client device.

9. The method of claim 8, wherein the event at the client device comprises an event selected from the group consisting of an onload event, an onshow event, an onfocus event, an onkeypress event, and an onkeydown event.

10. The method of claim 1, further comprising:
assembling a new information content that includes the browser command and excludes the scripting command.

11. The method of claim 10, wherein the new information content comprises an nScript browser command comprising a first division tag and a second division tag, wherein the first division tag identifies a group of related items, and wherein the second division tag identifies an item in the group of related items.

12. The method of claim 1, wherein determining a function of the scripting command comprises querying a database.

13. The method of claim 12, wherein the database stores one or more nScript browser commands.

14. The method of claim 13, wherein querying the database comprises:
formulating a query of the database, wherein the query comprises a keyword found in the information content; and
responsive to the query, retrieving one or more nScript commands stored in the database.

15. The method of claim 1, wherein determining a function of the scripting command comprises determining a function of the scripting command by use of a scripting language interpreter.

16. The method of claim 1, wherein determining a function of the scripting command comprises determining a function of the scripting command by use of a pattern recognizer.

17. A computer readable medium having stored thereon instructions for causing a processing unit to execute the method of claim 1.

18. A server comprising:
a processor for executing software applications stored in memory, the software applications including a server browser for:
(i) receiving an original information content from an information source, wherein the original information content includes a scripting command that is not executable on a client device,
(ii) determining a function of the scripting command,
(iii) determining a browser command to replace the scripting command, wherein the browser command performs the determined function of the scripting command and comprises an nScript browser command that is executable on the client device,
(iv) assembling a transformed information content by:
(a) removing the scripting command from the original information content,
(b) determining an insertion position within the original information content for a browser command, and
(c) inserting the browser command into the original information content at the insertion position; and
a client device interface for sending the transformed information content.

19. The server of claim 18, wherein the server browser determines one or more browser commands to replace the one or more scripting commands based on information stored in a database.

20. The server of claim 18, wherein the database stores the browser command, and wherein the browser command is retrieved based on a database query comprising the scripting command.
